(19) United States
(12) Patent Application Publication
(10) Pub. No.: US 2006/0282699 A1
(43) Pub. Date: Dec. 14, 2006

(54) Handling real-time write errors

(76) Inventors: Robert Albertus Brondijk, Eindhoven (NL); Stephen Josephus Maria Van Beckhoven, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,973

(22) PCT Filed: May 3, 2004
(86) PCT No.: PCT/IB04/50567

§ 371 Date: Nov. 17, 2005

(30) Foreign Application Priority Data
May 20, 2003 (EP) 03076514.3
Dec. 11, 2003 (EP) 03104636.0

(51) Int. Cl. G06F 11/00

(52) U.S. Cl. 714/5

(57) ABSTRACT

A recording device has medium interface means for interfacing with a storage medium for recording data on the medium and retrieving data from the medium, and host interface means for communicating with a host via messages according to a protocol (ATA/ATAPI). The messages include a write command for writing a series of data blocks in real-time. The device has error monitoring for generating an error message for notifying the host in dependence of an error status within the series of data blocks (84). The error status may indicate the location of a write error (85) in the series, or exceeding a timeout during recording (T_{RS}+T_{RET}+T_{CAL}).

The invention relates to a device for recording information on a storage medium, the device comprising medium interface means for interfacing with the storage medium for recording data on the storage medium and retrieving data from the storage medium, and host interface means for communicating with a host via messages according to a protocol, the messages including a write command for writing a series of data blocks in real-time.

The invention further relates to a method of error monitoring during recording on a storage medium, the method comprising communicating with a host via messages according to a protocol, the messages including a write command for writing a series of data blocks in real-time.

The invention further relates to a method of controlling the recording device, the method comprising communicating with the device via messages according to a protocol, the messages including a write command for writing a series of data blocks in real-time.

The invention further relates to a computer program product for error monitoring during recording on a storage medium, and for controlling the recording device.

Controlling of recording an optical record carrier via a recording device is known from the DVD (Digital Versatile Disk) system and a draft proposal of the National Committee for Information Technology Standards (NCITS): Working Draft, T10/1363-D, Revision 10g, Nov. 12, 2001, “INFORMATION TECHNOLOGY—SCSI Multimedia Commands—(revision MMC10g, in this document further called MMC-3). The device has a medium interface, e.g. a read/write head and positioning system, on one side to interface with the storage medium. On the other side, the recording device has a host interface to communicate with a host, which may be a PC or the application unit of a video recorder. A protocol for communicating between the host and the host interface of the recording device is the ATA/ATAPI standard referred to in MMC-3 (chapter 1) and in particular NCITS T13/1321D AT Attachment with Packet Interface 5 referenced in MMC-3 (chapter 2.1.2), or X3T13/1153D ATA-5 Rev. 17, further called ATA/ATAPI-5. Hence the device may be called an ATA/ATAPI device. Such recording devices are being used for recording real-time data blocks, e.g. video, under the control of the host system. The host accommodates applications like recording or playback of video. While a drive is writing an error can occur. For a applying a recovery process, the application needs to know the status of the error. In the known protocols, the application has a choice between fast writing a series of blocks with a lot of buffering in the drive, or slow writing with no buffering in the drive. The drive will report an error if the command could not be successfully completed. By writing block by block the location of the error is known after the drive responds to the command. By writing a series of blocks an error is reported for the total series of blocks. An application can either quickly write or easily find an error.

Therefore it is an object of the invention to provide an error monitoring system that allows real-time recording while write errors are handled efficiently.

According to a first aspect of the invention the object is achieved with a device for recording information as described in the opening paragraph, the device comprising error monitoring means for generating an error message for notifying the host in dependence of an error status within the series of data blocks.

According to a second aspect of the invention the object is achieved with a method of error monitoring as described in the opening paragraph, the method comprising generating an error message for notifying the host in dependence of an error status within the series of data blocks.

According to a third aspect of the invention the object is achieved with a method of controlling the recording device as described in the opening paragraph, the method comprising receiving an error message from the device in dependence of an error status within the series of data blocks, and applying a recovery for masking the error during playback of the series of data blocks.

The effect of the measures is that the device reports the write error in the error status to the drive. The error status for example includes a location of the write error within the series. This has the advantage that the application in the host may recover quickly from the error and continue recording as soon as possible.

In an embodiment of the device the error monitoring means are arranged for, in the event of write errors, including in the error message a location of a write error within the series of data blocks. This has the advantage that the host is aware of the location of the write error, and the resuming recording in a recovery process can be based on the known error location.

In an embodiment of the device the device comprises a cache buffer for storing the data blocks, and the host interface means are arranged for receiving a synchronize cache command for indicating an address in the cache buffer for resuming writing after a write error. This has the advantage that the host need not re-transfer data blocks after the error, but the blocks still present in the cache buffer are used.

In an embodiment of the device the host interface means are arranged for receiving a command that indicates a timeout during recording which timeout defines a maximum amount of time to be maximally used during recording for operations other than writing the data blocks, and the error monitoring means are arranged for determining an actual amount of time used during recording for said other operations, and for generating said error message when said actual amount exceeds said maximum amount. This has the advantage that such a timeout is independent of the execution time of the intended writing operations, and indicates an overall spare time not to be exceeded during executing the command.

Further preferred embodiments of the method and device according to the invention are given in the further claims.

These and other aspects of the invention will be apparent from and elucidated further with reference to the embodiments described by way of example in the following description and with reference to the accompanying drawings, in which

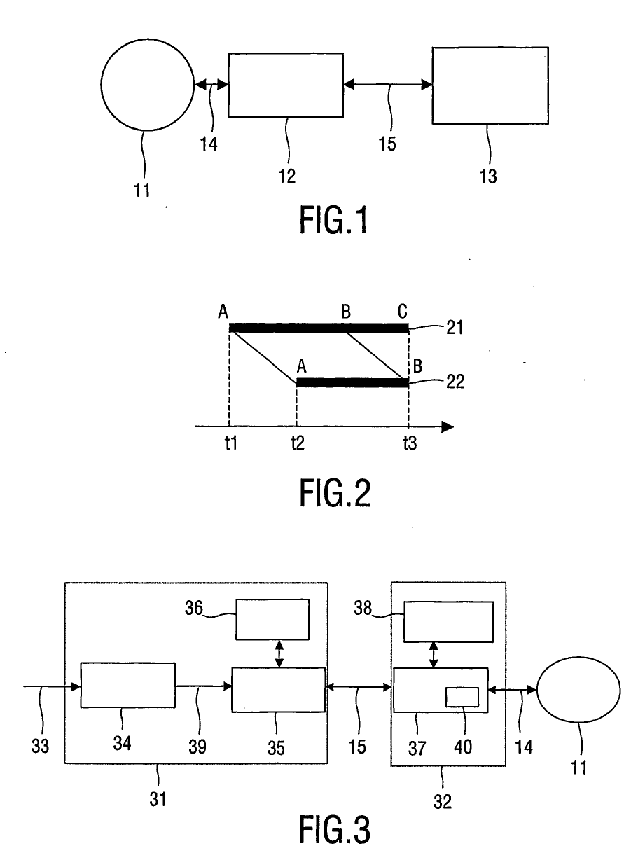

FIG. 1 shows a disc-shaped storage medium, recording device and host system,

FIG. 2 shows a time diagram of delays between date on the host interface and data delivered to the storage medium,

FIG. 3 shows a host including an application, a recording device and storage medium,

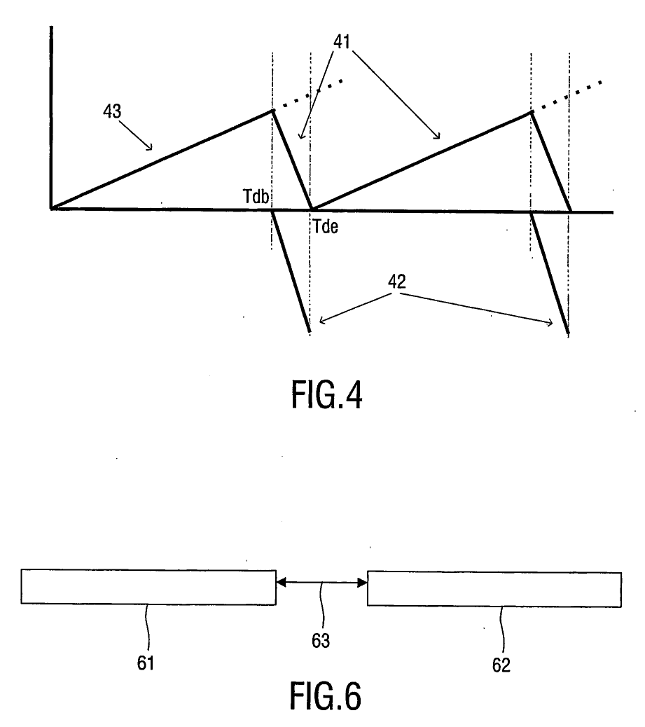

FIG. 4 shows a graph of data generated, transferred and written to a disc,

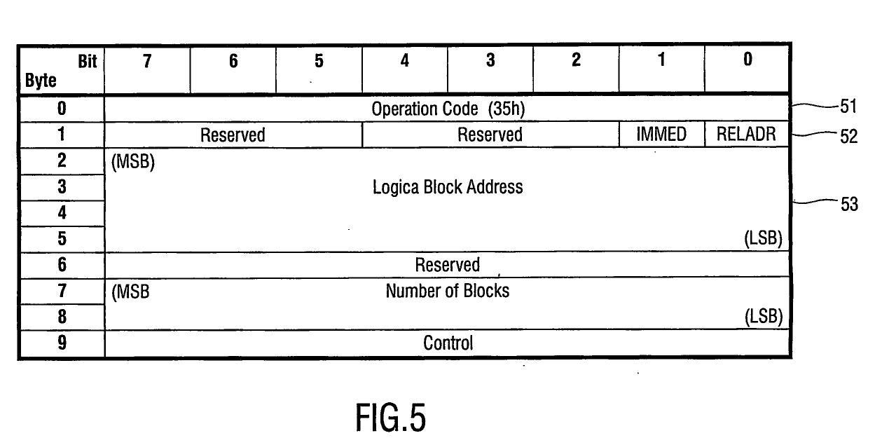

FIG. 5 shows a synchronize cache command,

FIG. 6 shows a timing diagram of a command and response,

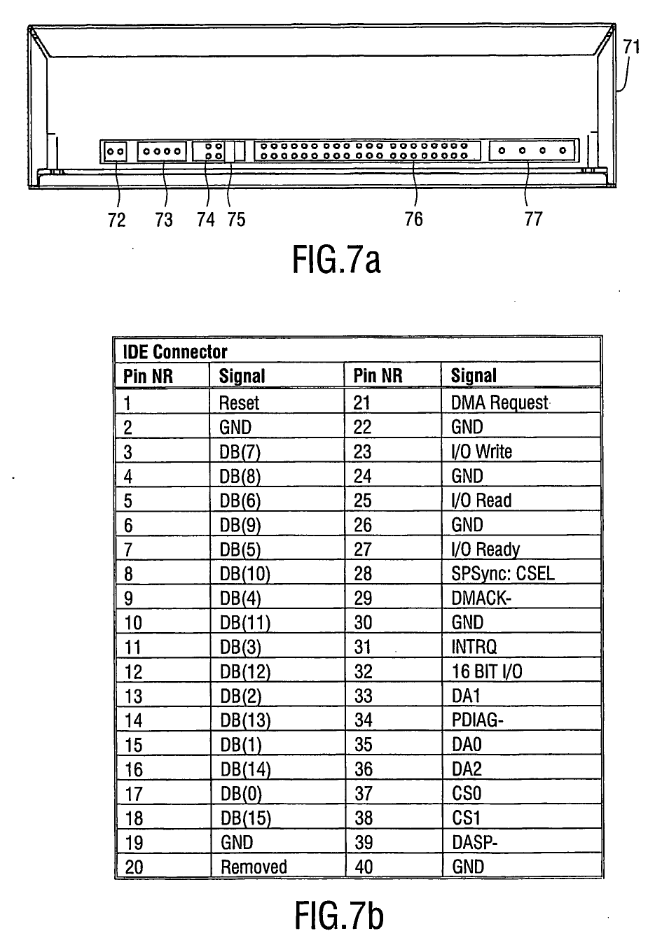

FIG. 7a shows connectors on a drive for interfacing,

FIG. 7b shows an IDE connector layout,

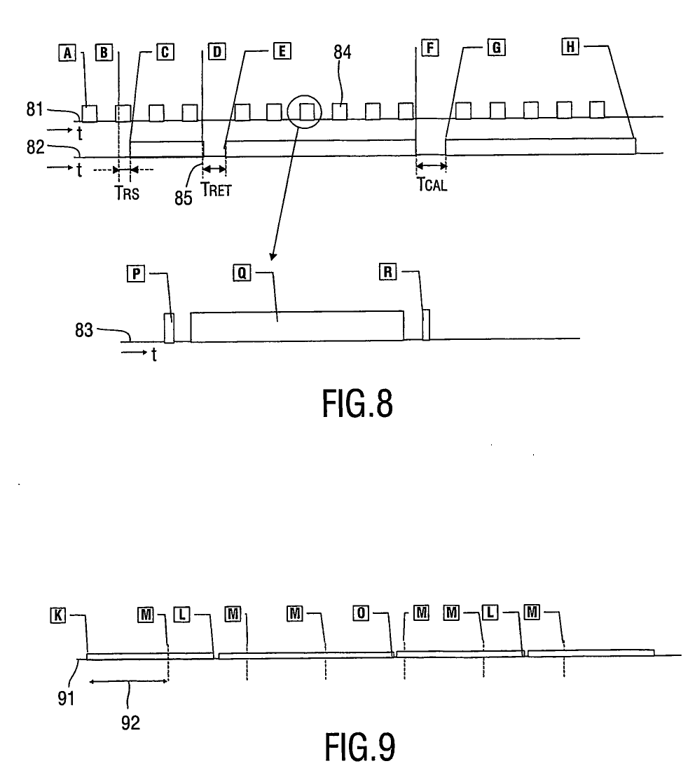

FIG. 8 shows a timing diagram of messages on the host interface, writing operations and other operations during recording, and

FIG. 9 shows a timing diagram of writing operations and a window structure for timeout.

In the Figures, elements which correspond to elements already described have the same reference numerals.

FIG. 1 shows a disc-shaped storage medium, recording device and host system. A storage medium 11, for example an optical disc, constitutes a record carrier for a recording device 12. A DVD+RW is an example of such a record carrier. A number of interfacing functions of the recording device is defined according to a predefined standard, for example ATA/ATAPI-5. Hence the device may be called an ATA/ATAPI device. The device (12) has a medium interface, e.g. a read/write head, positioning servo system and control circuits commonly known from the CD or DVD system, on one side to interface with the storage medium 11, for example the DVD+RW disc. On the other side, the device 12 has a host interface 15, e.g. an ATA cable or a serial interface, to communicate with a host, which may be either a PC or the application side of a video recorder, e.g. having usual elements for input and output of video information. The combination of the four elements: DVD+RW medium, an ATA/ATAPI device plus Host, can form a Consumer DVD+RW Video Recorder. The main focus of this invention is of the application in a DVD+RW Video Recorder.

Background information on the recording devices and storage medium formats can be found in the following references:
[DVD] Specification for Read-only disc ECMA-267
[DVD+R] 4.7 Gbytes Basic Format Specifications System Description 1.1
[DVD+RW] 4.7 Gbytes Basic Format Specifications ReWritable version 1.2

Commonly in recording systems the following definitions are used.
Drive: The unit that interfaces to the storage medium, e.g. has an Optical Pick-up Unit, servo, data-path, memory flash, and which is interfaced to a host, e.g. with ATAPI.
Disc: Can be any optical disc, e.g. CDDA, CD-R/RW, CD-ROM, DVDROM, DVD+RW, DVD+R SACD
ECC: This is the smallest data amount that can be written on the disc. On DVD a complete EFM block of 32 Kbytes user-data.
Sector: Is the minimum data size that can be addressed (on DVD) 2048 Bytes
Application: Active unit in a host to interface with, which requires real-time data to be stored on the disc (and retrieved from) the disc, and arranges the structure on the disc, and that is for example encoding/decoding the video signals.
De-iced: The +RW phase change material has two states: amorphous or crystalline. All of the material on a new disc has the same state; such a disc is referred to as “iced”. By writing to the disc, transitions are created. This influences the reflectivity of the disc and how the disc can be read. If the disc contains iced areas, the current position of the laser can only be determined by via the wobble. In written areas, the position information is included in the data.
Chunk a block of data to be written continuously without linking.
Off-Track When the laser in the optical pickup unit can not follow the (wobbled) groove on a (recordable) disc it will be off track.

In the following the medium and the protocol over the host interface 15 or ATA cable will more deeply be described. There is a problem in the definition of the protocol as given in MMC-3 and by understanding the relationship between the medium and the protocol, the solution to this problem can be understood.

The ATA cable and its protocol, that are well-known, are described in numerous documents, e.g. the ATA/ATAPI-5 document. The highest protocol level of the cable is given in MMC-3. In the following explanation the storage medium 11 is a DVD+RW medium, a recordable Digital Versatile Disc. The medium is described in the DVD+RW Physical Format Specification.

The problems, which are addressed here, are caused by write errors. The application which is being executed in the host, is writing data to the disc in real-time. If an error occurs the application wishes to recover from that error and continue recording as soon as possible. It is assumed that, at the application level, the recovery will mask the error. In the case of a video recorder, the recovery may be a mask constituted by a segment of video that will be skipped over during playback. The key is to keep that mask, or piece of video, as small as possible. Hence the host interface communicates with the host via messages according to a protocol (e.g. ATA/ATAPI-5), the messages including a write command for writing a series of data blocks in real-time. For quickly reporting the error the device has error monitoring means for generating an error message for notifying the host in dependence of an error status within the series of data blocks. Generally the communication of the error message achieves that the application is notified of the error as soon as possible, and reports the error status. In an embodiment the error status includes the error location.

FIG. 2 shows a time diagram of delays between date on the host interface and data delivered to the storage medium. In the upper curve 21 the data at the host interface (ATA/ATAPI cable) are indicated. Some data blocks are marked A,B,C. Data block A arrives at time t1 on the host interface. The lower curve 22 indicates the same data elements at the storage medium interface. Data block A arrives at t2. There are two basic problems which must be overcome to give an application an error notification as soon as possible. The first problem is the inherent delay between sending data over the ATA/ATAPI cable and the data written to the disc, as indicated by the time difference between the curves 21,22. A second problem is the burst character of the data being send over the cable. These two problems are more deeply described now.

Firstly, about inherent delay between the data delivered over the ATA/ATAPI cable, and the data being delivered to the disc. The time diagram of FIG. 2 shows the data transferred over the ATA/ATAPI cable represented by the top curve 21, from A, through B to C. The transfer begins at t1. At t2, the data is written to the disc. At t3, an error occurs at position B in the data stream. At the time of the error, the stream over the ATA/ATAPI cable is already at position C.

The second problem is the burst character of data over the ATA/ATAPI cable. The source of this problem occurs when delivering compressed video, as explained with FIG. 3.

FIG. 3 shows a host including an application, a recording device and storage medium. A host 31 has a Video Encoder 34 for receiving video on a video input 33, an Interface 35 (coupled to a recording device 32 via a cable) and a memory 36. The “dig” connection 39 between the Video Encoder and the Interface is referring to some kind of digital interface. The device 32 contains a drive 37 for interfacing to the storage medium 11 via a medium interface 14 and a memory 38. The device contains an error monitoring unit 40 for generating an error message for notifying the host in dependence of an error status within the series of data blocks as described below.

In practice, the maximum bit-rate of the encoder 34 is much lower than the write speed of the drive 37 to the medium. When the encoder delivers its encoded output to the ATAPI/ATA device, the following occurs. Let Bs be the bit-rate of the data over “dig” connection 39, Bd be the bit-rate of the data over the medium interface 14 and Md the amount of memory 38 of the drive and Ms the amount of memory 36 available in the host to the Interface. Md/Bs is the amount of time the drive will accumulate the data. Md/Bd is the amount of time the drive will write to the medium. Ms, is minimally of 2 k is needed, as this is the smallest amount of data which can be written to the drive. Ms/Bs is the interval time between data bursts to the device.
Example of data transfers on the host interface:
Let Ms=2 KB (KiloByte), Bs=8 Mb/sec (MegaBit/second), then
2 KB/8 Mb/sec=2*8/8=2 msec interval time between bursts
Example of time needed to write a full buffer contents to the medium:
Let Md=2 MB and Bd=24 Mb/sec, then
2 MB/24 Mb/sec=2* 8/24=2*8/3*8=⅔=0.666 sec.
In a practical device additional access time is needed before data can be recorded.

FIG. 4 shows a graph of data generated, transferred and written to a disc. An upper part 41 of the graph shows a host buffer filling, while a lower part 42 shows device write operations. In a first part 43 the buffer in the host is filled due to the data generation of the encoder 34. In a second part the buffer is emptied by a device write 42. The time interval for buffer filling Tdb, and the time for buffer emptying Tde can be calculated as indicated above with FIG. 3.

Overhead during recording is caused by accessing, and efficiency can be calculated as follows:
Ta==access time
Td==Time needed to write a series of data blocks (also called chunk)
Efficiency=Td/(Ta+Td)
Efficiency can be increased by maximizing Td, or chunk size.
Bde=Ms/(Ta+Ms/Bd)=Bd/(Bd*Ta/Ms+1)
By increasing Ms the effect of Ta is reduced. You also see that by increasing the drive's write speed, the chunk must also be increased to retain the same efficiency. We also see that the time between chunks increases linearly since T=Ms/Bs.

### EXAMPLE

| | | |
|---|---|---|
| Ta= | 200.00 | ms |
| Ms= | 40.00 | Mb |
| Bd= | 26.00 | Mb/s |
| Bde= | 23.01 | Mb/s |
| Efficiency= | 0.53 | |

In an embodiment an algorithm is described for writing a series of data blocks in real time and responding to write errors. First the data is delivered in chunks (not continuously in a small amounts), to maximize the amount written by the drive and the efficiency. The memory in the host must be larger than the chunk size to avoid memory overflows during recoveries and re-tries by the drive. At the end of a chunk, a command is selected or additionally given to force unit access before delivering the next chunk. By forcing unit access, any error will be reported at the end of the current chunk instead of the beginning of the next one. The time difference is between reporting at the end and reporting at the next beginning is Ms/Bs. In practice, Ms=5 MB and Bs=1 MB/sec, then Ms/Bs=5 sec. The access can be forced via either the FUA bit in the write command (see MMC-3) or by issuing a Synchronize Cache command discussed below.

In an embodiment the drive will abort a UDMA/DMA transfer at the moment of a write error. The drive does not complete the whole transfer. This is relevant if the transfers are larger than several hundred kilobytes.

In an embodiment the host also specified a maximum number of retries and an overall error-time-out via a mode-page. This may also be a reason for an error message.

In an embodiment the drive will report via Request Sense command, the address at which the error occurred. The host may assume that the ECC block that follows the ECC block in which the error occurred, is still totally unwritten, and therefore can be written to. This is important for DVD+R because writing can only occur in whole ECC blocks.

In an embodiment, after an error, the host issues a Synchronize Cache command with an Address parameter to say from which block in the cache writing can resume. These will be blocks with a higher address than the address at which an error occurs.

FIG. 5 shows a synchronize cache command. The definition of the synchronize cache command shows an operation code 51, a parameter byte 52 having a bit IMMED indicating a type of execution and response of the command, and further parameters like RELADR indicating relative addressing. A set of bytes 53 indicates the Logical Block Address. The idea is to use the Logical Block Address (LBA) to point to a block in the cache. The device must find the block in the cache with that LBA. All blocks in the cache with that LBA and higher, must be written to the disc. Alternatively all blocks written to the drive after the indicated block, with a higher LBA, will be written to the disc.

It is noted that the process of error monitoring and reporting as described above can be used for DVD+RW as well as for DVD+R. This implies that it is possible to skip areas on a DVD+R media without giving a “reserve track” command. Key points of the process are the following. By working in chunks, the number of write links is minimized. A write link is when the drive stops writing and continues later from the place it stopped. By minimizing the number of links, the chance of write error decreases and the direct overwrite (DOW) of the disc is kept low. By forcing unit access at the end of each chunk, the error detection time is kept minimal, and therefore recovery is quick. This saves memory on the host side, because new real time data generated during recovery needs to be buffered.

Supporting a special sync-cache type of feature such as the cache command, the host needs not re-transfer blocks after an error. This is especially important if the host works with large transfer lengths and if the drives' internal memory is large. Hence the device comprises a cache buffer for storing the data blocks, and the host interface receives a cache command for indicating an address in the cache buffer for resuming writing after a write error. In particular the address in the cache command is a logical block address of the data block to resume writing, or indicates the data block with the next higher logical block address as the data block to resume writing. Important is the function of resuming recording using data blocks already present in a buffer in the recording device, and not the particular sync cache command described above.

It is noted that on a write once storage medium a skip function is supported, e.g. on DVD+R. In general, we increase DVD+R from a sequential write medium to a medium which allows forward jump. Skipped blocks are considered written by the device and will be administered as such in the disc status, e.g. the recorded area indicator (RAI). Important is also the devices' willingness to break off a large transfer in case of a write error.

In an embodiment a time-out time is specified via a special command along with a number of retries. This is further described below.

FIG. 6 shows a timing diagram of a command and response. After sending a command and corresponding data 61 via the host interface 15, there is a command complete response 62. The time 63 between command 61 and command complete 62 is further defined to achieve a timely error status reporting. MMC-3 only specifies transfer rates, but not the time lapse between the last transferred byte and the command complete response 62 of the drive. The solution is either to directly specify the time directly. A direct definition is to specify the maximum time lapse and call it “command-time out” or “maximum allotted time”. The command time-out may be applied for many commands. The time-out is the maximum time between the command and command complete. If the drive has to internally abort a command to achieve this, it must return with an error.

It is noted that a number of retries may be specified also. A read command can be delayed because a drive can not find the required address. It goes through a loop: jump & read address, if unsuccessful, jump and read again. By limiting the number of retries, the imminent read error is reported earlier, and thereby ending the command earlier.

FIG. 7a shows connectors on a drive for interfacing. A rear side 71 of a drive is shown. The connector in the rear side of the drive is a 5-in-1 connector. A first connector 72 is a digital output, and a second connector 72 is an analogue audio output (4 pin, according to MPC-2 spec). The audio outputs may be not supported. A Master/Slave connector 73 is a 3 position jumper block, for CS (Cable Select), M (Master) and S (Slave), and a jumper 75 is shown in a position as default jumper master select. A fourth connector 76 is a 40 pin ATA-2 dual row flat-cable connector, shrouded & keyed (pin 20 removed). This connector, also called IDE connector, is used for interfacing to a host via an ATA cable as described in ATA/ATAPI-5. Finally a connector 77 is a DC Power inlet according to Industry std. 4-pin Amphenol. The DC Power Connector provides the drive with DC power (+5 Volt and +12 Volt) to be supplied from an external power supply.

FIG. 7b shows an IDE connector layout defining the function of the pins. The data connector is used for interfacing to a host system. For a detailed description see ATA/ATAPI-5. The Master/Slave Connector 73 is used to install an IDE data cable depending on the existing PC configuration. There are three possibilities of connection: device as slave (jumper on Slave); device as master (jumper on Master Default); device as master or slave (jumper on Cable Select): depending on the configuration of another connected device. No Jumper also means Cable select.

It is noted that MMC-3 is not enabling recovering from a write error by the drive with respect to real time recording. It is proposed to make capabilities available in the drive to do recovering during write and during read. The MMC-3 includes only the amount of retries and a command timeout. The command timeout is the maximum time to sending a message that the command has been executed. This command time out cannot be used for a recovery function because the command completion will send directly after receiving the data. Hence in MMC-3 the error status during writing a series of data blocks cannot be reported to the host.

In an embodiment a solution is provided in the event that real-time recording is to be performed. For example in real-time recording during writing a “disc at once” the host (e.g. in a PC) is following the drive. When a recovery process is activated in the drive the host has to wait until the drive has finished the recovering. The waiting during real time recording may cause the data storage to create a buffer overflow, and therefore a need to skip data This gives a poor recording with visible skipped data. To improve this in the embodiment a timeout during recording is included. The definition of the timeout during recording is all time what is used doing “not writing” during execution of the write command, starting after the buffer level is crossing the threshold level of the data path buffer, and ending until the last part is written. The timeout during recording is different from the command timeout in that the command timeout defines the maximum total execution time, while the timeout during recording defines the maximum amount of spare time for other operations than the writing itself. This is further explained below.

FIG. 8 shows a timing diagram of messages on the host interface, writing operations and other operations during recording. An upper timeline 81 shows messages at the host interface, i.e. the IDE level. The messages constitute a series of data blocks 84 to be recorded in real-time. A lower time line 82 shows operations at the medium interface, i.e. the disc level. On the upper timeline 81 mark A indicates a start of a sequence of write commands, wherein the next write command can only be given if the device has enough room to store the data in a buffer. Mark B indicates a crossing of a buffer threshold level. The buffer threshold level is a minimum amount of data that needs to be in the buffer before the device can start writing. After a delay T_{RS} for starting the write process the drive start writing to the media indicated by mark C. A write error 85 occurs at mark D, e.g. an off_track error, and a time T_{RET} is needed to do recovering in the device. If the recovery is not successful the writing process is aborted and an error message is generated indicating the location of write error 85. After a successful recovery the device again starts writing continuously at mark E. At mark F a calibration is needed which required is time T_{CAL} for performing the calibration. At mark G the device again starts writing after calibration. At mark H the device finishes the writing process. A bottom timeline 83 shows a detail of a write command on the upper timeline 81 to explain the write command. At mark P an IDE write command is send to the drive. The command is followed by a data transfer to the drive at mark Q. At mark R a command completion message is send to the host. Note that the transferred data is not yet written on the storage medium, and therefore the existing command timeout which is coupled to the command completion message cannot be used to transfer en error status of the writing process itself.

In an embodiment the time out during recording is defined as
T_{OUT}=T_{RS}+T_{RET}+T_{CAL}
Hence the device adds the actual time used for the above elements and compares the total T_{OUT} to the maximum value given to the device, e.g. as a parameter included in a command. If the maximum value is exceeded by the actual calculated value, the writing process is aborted, an error message is generated and reported to the host.

In an embodiment the timeout during recording is defined as a fixed time the host has to preset every time the sequence to be written is different in time.

### Example 1

during writing 3 Mbyte the timeout during recording could be set to 500 msec. When the T_{OUT} is above the given value of timeout during recording the drive stops the current operation, such as retries or calibration, and sends an error to the drive. For writing a much larger amount of data, e.g. the host wants to write 500 Mbyte, using the same timeout during recording of 500 msec, a second calibration will create an error. This is unwanted because on a larger chunk of data to be recorded the host can expect one or more calibrations. Hence the host needs to set a larger timeout during recording for writing a large chunk.

In an embodiment the idea is to use a window structure and reset the actual time for other operations like calibration (T_{OUT} counter) after each window (for example the window is 20 sec). Hence the maximum given in the timeout during recording is defined as a maximum in the current window. In this way the T_{OUT} calculation can be used for every length of data to be recorded. Hence it is not necessary to set the timeout during recording every time when the length of data to be recorded is changed. In a practical example the T_{OUT} counter is reset during start recording and after each window of 30 sec. The reset and window is explained by the diagram in FIG. 9 below.

FIG. 9 shows a timing diagram of writing operations and a window structure for timeout. A time line 91 shows writing operations at the medium interface, i.e. the media write level. At mark K recording is started, and a window 92 begins. At the first mark M the window is closed, and at each mark M a new window begins. At each mark M the T_{OUT} counter is reset. During each window the calculation of T_{OUT} is performed, and if the actual T_{OUT} exceeds the timeout during recording an error is reported as described above. For example at mark L a calibration is executed, and at mark O a write error occurs, but retries are successful. No error is reported and writing is continued.

Although the invention has been mainly explained by embodiments using DVD+RW optical discs, the invention is also suitable for other record carriers such as rectangular optical cards, magneto-optical discs, high-density (Blu-ray) discs or any other type of information storage system for recording series of data blocks in real time.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for recording information on a storage medium (11),
the device comprising
medium interface means (14) for interfacing with the storage medium (11) for recording data on the medium and retrieving data from the storage medium,
host interface means (15) for communicating with a host (13) via messages according to a protocol, the messages including a write command for writing a series of data blocks in real-time, and
error monitoring means (40) for generating an error message for notifying the host in dependence of an error status within the series of data blocks.

2. Device as claimed in claim 1, wherein the error monitoring means (40) are arranged for, in the event of write errors, including in the error message a location of a write error within the series of data blocks.

3. Device as claimed in claim 1, wherein the error monitoring means (40) are arranged for, in the event of write errors, reporting via a request sense command the address at which a write error occurred.

4. Device as claimed in claim 1, wherein the host interface means (15) are arranged for receiving a command that forces unit access for sending the error message at the end of the series of data blocks.

5. Device as claimed in claim 1, wherein the device comprises a cache buffer (38) for storing the data blocks, and the host interface means (15) are arranged for receiving a cache command for indicating an address in the cache buffer for resuming writing after a write error.

6. Device as claimed in claim 5, wherein the address in the cache command is a logical block address of the data block to resume writing, or indicates the data block with the next higher logical block address as the data block to resume writing.

7. Device as claimed in claim 1, wherein the host interface means (15) are arranged for receiving a command that indicates a timeout during recording which timeout defines a maximum amount of time to be maximally used during recording for operations other than writing the data blocks, and the error monitoring means (40) are arranged for determining an actual amount of time used during recording for said other operations, and for generating said error message when said actual amount exceeds said maximum amount.

8. Device as claimed in claim 7, wherein the error monitoring means (40) are arranged for determining said actual amount of time in a time window and for setting subsequent time windows during recording.

9. Method of error monitoring during recording on a storage medium,
the method comprising
communicating with a host via messages according to a protocol, the messages including a write command for writing a series of data blocks in real-time, and
generating an error message for notifying the host in dependence of an error status within the series of data blocks.

10. Method as claimed in claim 9, wherein generating the error message comprises, in the event of write errors, including in the error message a location of a write error within the series of data blocks.

11. Method as claimed in claim 9, the method comprising
storing the data blocks in a cache buffer, and
receiving a synchronize cache command for indicating an address in the cache buffer for resuming writing after a write error.

12. Method as claimed in claim 9, the method comprising receiving a command that indicates a timeout during recording which timeout defines a maximum amount of time to be maximally used during recording for operations other than writing the data blocks, and determining an actual amount of time used during recording for said other operations, and generating said error message when said actual amount exceeds said maximum amount.

13. Method of controlling a recording device as claimed in claim 1, the method comprising
communicating with the device via messages according to a protocol, the messages including a write command for writing a series of data blocks in real-time, and
receiving an error message from the device in dependence of an error status within the series of data blocks, and
applying a recovery for masking the error during playback of the series of data blocks.

14. Method as claimed in claim 13, wherein said communicating includes sending a command that forces unit access for receiving the error message at the end of the series of data blocks.

15. Method as claimed in claim 13, wherein said communicating includes sending a synchronize cache command for indicating an address in a cache buffer in the recording device for resuming writing after a write error.

16. Computer program product for recording information, which program is operative to cause a processor to perform the method as claimed in claim 9.
